(19) United States
(12) Patent Application Publication
(10) Pub. No.: US 2008/0010180 A1
(43) Pub. Date: Jan. 10, 2008

(54) Trust information management system

(75) Inventors: John K. Russ, New York, NY (US); Dan Singer, New York, NY (US); Akshay Murthy, New York, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/802,263

(22) Filed: May 21, 2007

Related U.S. Application Data
(60) Provisional application No. 60/801,902, filed on May 19, 2006.

(51) Int. Cl. G06Q 40/00

(52) U.S. Cl. 705/36 R

(57) ABSTRACT

A system includes a database including data for at least one trust and at least one bond, the data of at least one bond being associated with at least one trust holding at least one bond, the data of the at least one trust including at least floater data, and a server to manage the data of the at least one trust and the data of the at least one bond associated with the at least one trust.

This application claims the benefit of the U.S. Provisional Patent Application No. 60/801,902 filed on May 19, 2006, which is hereby incorporated by reference.

### BACKGROUND OF THE INVENTION

1. Field of the Invention

The present invention relates to a trust information management system.

2. Discussion of the Related Art

In the municipal bond market, trusts can be used to create a highly leveraged but liquid tax-exempt instrument. In particular, municipal bonds are deposited into a trust where the trust issues two classes of trust receipts: (1) a floating rate trust receipt (“floaters”) and (2) a residual interest trust receipt (“inverse floaters”).

In general, floating rate trust receipts bear interest at short term tax-exempt rates. Holders of the floating rate trust receipts have the option to tender the floating rate trust receipts to the trust at par, protecting investor principal. The tender option is supported by a standby liquidity facility, such as Lehman Liquidity Company. Floating rate trust receipts bear long term ratings of the underlying bonds and the short term ratings of the liquidity provider. The floating rate trust receipts may be reset in weekly, quarterly, or other term modes. The holders are entitled to a minimum of 5% share of any gain on the underlying bonds at trust termination.

Residual interest trust receipts are inverse floaters, which receive the residual interests on the underlying bonds after the interests are allocated to first pay the floater rate trust receipts, less any fees. Therefore, the structure enables the residual interest trust receipt holders to achieve economic equivalent of financing a position in the underlying bonds at short-term tax exempt rates, which are generally the lowest rates available in the U.S. fixed-income market place. The residual interest trust receipt holders can retain an option to call the floater rate trust receipts, subject to certain conditions. This option preserves liquidity and allows for a timely termination of the trust. Leverage can range from 50% to almost 100% and the degree of leverage is subject to credit approval.

In general, residual interest trust receipts provide enhanced tax-exempt yield as long as the short term tax-exempt rate is below the yield on the underlying bonds. The traditional steepness of the tax-exempt yield curve allows for a yield pickup of about 100-300 basis points on the par value of floater rate trust receipts. Moreover, leverage magnifies the price performance of the residual interest rust receipts. For instance, for a structure employing 1:1 leverage, a one-half (½) point move in the underlying bonds will result in a one (1) point move n the value of the residual interest trust receipts. Therefore, as leverage increases, so will the magnification of the change in the residual interest trust receipt value relative to the change in the value of the underlying bonds.

Rates for the floater rate trust receipts are determined by remarketing agents on each weekly, quarterly, or term reset date. The reset rate is equal to the rate of interest necessary to enable the remarketing agent to sell the floater rate trust receipts at a price equal to par for the interest period. The floater rate trust receipts are converted to fixed rate receipts after gain determination if the residual interest trust receipt holders do not elect to pay the gain and on the final gain determination. The floater rate trust receipts remain outstanding to maturity as floater rate receipts if there is no gain on the bonds.

If a final tender event occurs, including a failed remarketing, the trust is terminated and the bonds are sold. The liquidity facility will fund the difference, if any, between the sale proceeds of the bonds and the purchase price (par plus accrued) for the floater rate trust receipts. If the bonds default, get downgraded below investment grade, or are deemed taxable, the liquidity facility terminates without a draw and the bonds are distributed to trust receipt holders. If the liquidity facility is drawn, the residual interest trust receipt holders will be required to reimburse the amount of the draw.

The gain determination date is the date that is 80% of the time from the inception of the trust to the expected life of the bonds. Gain is determined by obtaining bids for the bonds. If there is a gain, the residual interest trust receipt holders have the ability to pay the gain and leave the floating rate trust receipts in the floating rate mode. If the residual interest trust receipt holders do not pay the gain, the floater rate trust receipts are converted to fixed rate receipts with the gain reflected in the rate. If there is no gain, the floater rate trust receipts will remain outstanding to the maturity of the bonds. The floater rate trust receipt holders are entitled to a minimum of 5% gain share on the bonds underlying the floater rate trust receipts.

If the residual interest trust receipt holders pay the gain, a second gain determination is made on the date that is 80% of the time to the remaining expected maturity. If there is again at that time, the floater rate trust receipts are converted to fixed rate receipts with the gain reflected in the rate. If there is no gain at the time, the floater rate trust receipts remain outstanding to the maturity of the bonds. The final tender events, which result in a mandatory tender of the floating rate trust receipts and a sale of the bonds, include: (1) value of the bonds falls below a pre-set level, (2) the liquidity facility is not renewed or is terminated early for any reason, (3) the floating rate trust receipts cannot be remarketed, or (4) the liquidity provider becomes insolvent.

Typically, the trust administrator, or trustee, collects the information regarding the trust, as described above, and provides the information regarding the trust to the clients (i.e., receipt holders). The trustee receives information about the trust (e.g., data regarding the underlying bonds) from disparate sources. The trustee, then, must process the information regarding the trust and disseminate the information to the clients. Moreover, for clients who hold more than one trust must be able to keep track of all the trust information in order to monitor the activities regarding the underlying bonds as well as the critical event dates in order to efficiently manage the trusts. However, because the information being provided to the trustee, and therefore the information being provided to the clients from the trustees, comes from disparate sources with differing formats and notations, management of the trust is extremely difficult and time consuming, especially if there are several trusts to manage. Additionally, there currently is no system that provides the inverse floater bond rate and interest information for the residual interest trust receipt holders. Accordingly, there is a need for a system that consolidates all the information regarding a trust to a client for efficient monitoring and management of the trust regardless of whether the client is a floater rate trust receipt or residual interest trust receipt holder.

### SUMMARY OF THE INVENTION

Accordingly, the present invention is directed to a system for managing trust information that substantially obviates one or more problems due to limitations and disadvantages of the related art.

An object of the present invention is to provide a single computer platform to monitor and manage all the information of a trust.

Another object of the present invention is to provide system for managing both floating rate trust receipts as well as residual interest trust receipts.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system includes a database including data for at least one trust and at least one bond, the data of at least one bond being associated with at least one trust holding at least one bond, the data of the at least one trust including at least floater data, and a server to manage the data of the at least one trust and the data of the at least one bond associated with the at least one trust.

In another aspect, a device includes a communication unit to communicate with a database, the database including data for at least one trust and at least one bond, the data of at least one bond being associated with at least one trust holding the at least one bond, the data of the at least one trust including at least floater data, a computing unit to process the data for the at least one trust and the data of the at least one bond associated with the at least one trust, and a display unit to display the data of the at least one trust and the data of the at least one bond associated with the at least one trust.

In yet another aspect, a computer program product including computer executable instructions embodied on a computer readable medium, the instructions, when executed on a computer, causes the computer to perform a method that includes the steps of communicating with a database, the database including data for at least one trust and at least one bond, the data of at least one bond being associated with at least one trust holding the at least one bond, the data of the at least one trust including at least floater data, processing the data for the at least one trust and the data of the at least one bond associated with the at least one trust, and displaying the data of the at least one trust and the data of the at least one bond associated with the at least one trust.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram of an exemplary system architecture in accordance with the present invention;

FIGS. 2A-2C are block diagrams of exemplary data structures in accordance with the present invention;

FIG. 3 is a screenshot of a Trust Search module in accordance with an exemplary embodiment of the present invention;

FIG. 4A is a screenshot of a Bond Details module in accordance with an exemplary embodiment of the present invention;

FIG. 4B is a screenshot of a Trust Details module in accordance with an exemplary embodiment of the present invention;

FIG. 4C is a screenshot of a Trust Statistics module in accordance with an exemplary embodiment of the present invention;

FIG. 4D is a screenshot of a Pricing module in accordance with an exemplary embodiment of the present invention;

FIG. 5 is a screenshot of a Rate History module in accordance with an exemplary embodiment of the present invention; and

FIG. 6 is a screenshot of an Event Calendar module in accordance with an exemplary embodiment of the present invention.

FIG. 7 is a screenshot of a Floater Inventory module in accordance with an exemplary embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

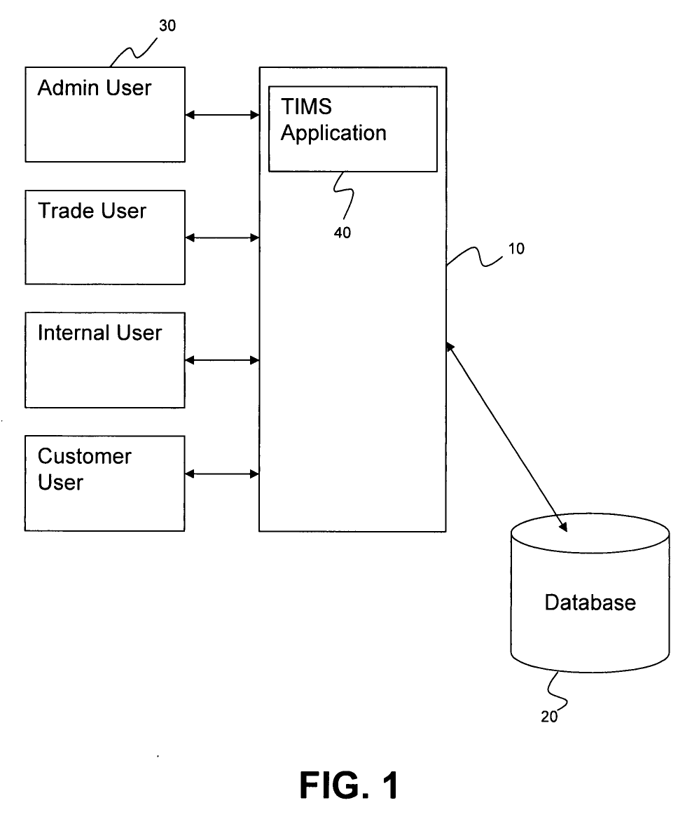

The present invention is directed to a system for managing trust information. In particular, FIG. 1 shows a block diagram of a trust information management system (“TIMS”) architecture in accordance with an exemplary embodiment of the present invention. As shown in FIG. 1, the TIMS architecture includes a TIMS server 10 connected to a database 20. The TIMS server 10 may be accessed by various remote devices 30, such as computer workstations, portable computers, handheld devices, and the like. Various users may access the TIMS server 30 using the various remote devices 30. For example, the users may be administrators, traders, internal users, and customers. Examples of users may be clients, trust counsel, trustees, broker/dealers, sales, and operational personnel. The remote devices 30 may connect to the TIMS server via wired or wireless connections. The connection may be a local area network (LAN), wide area network (WAN), wireless network (WiFi), or direct connections through a modem, for example. Other devices and connections may be used without departing from the scope of the invention.

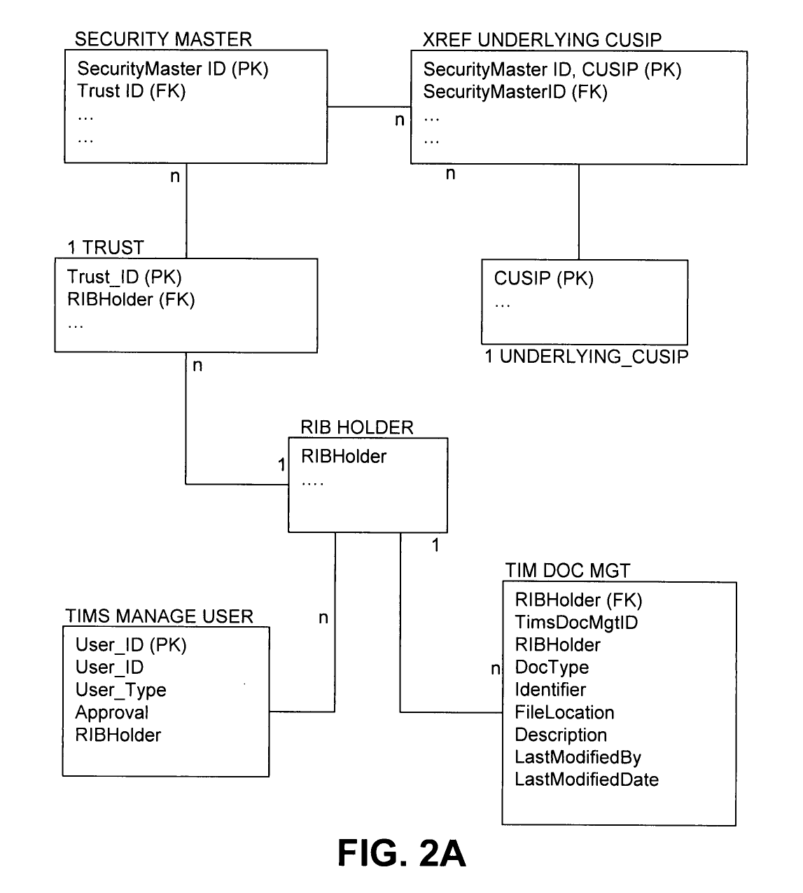

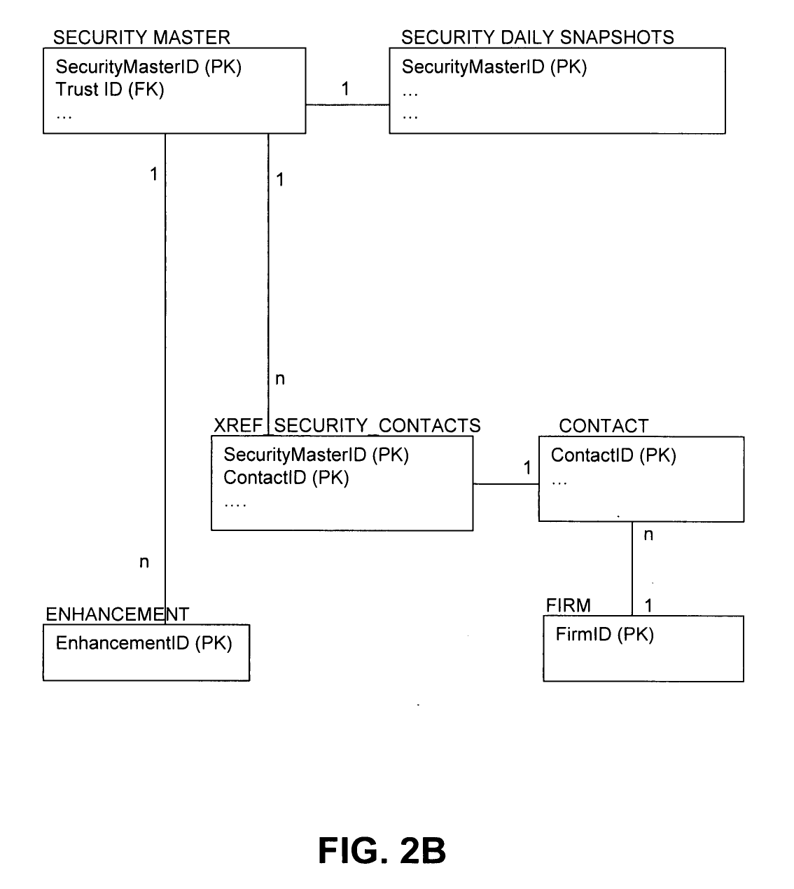

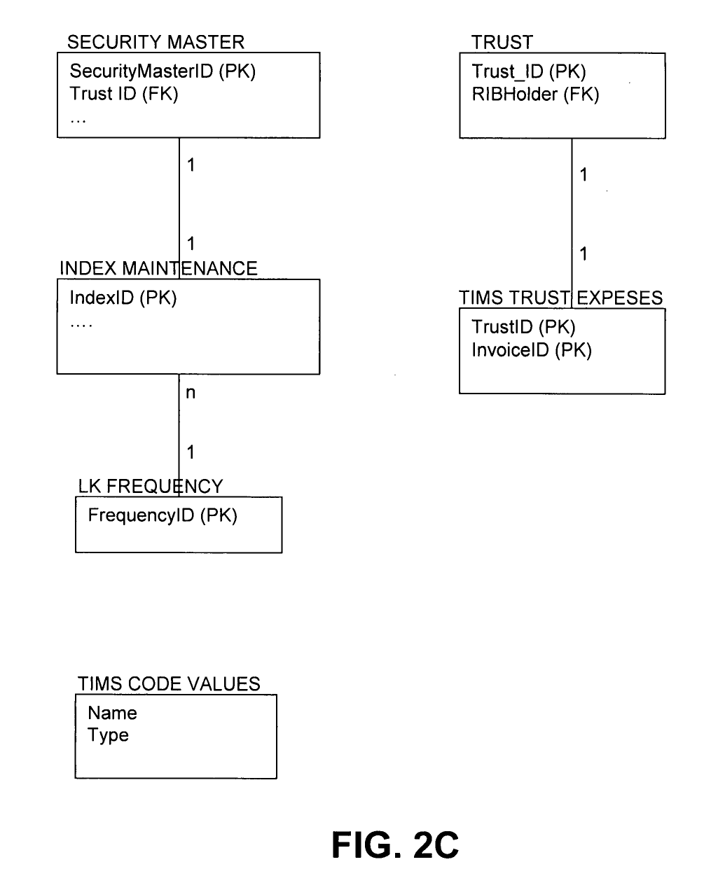

The database 20 stores information about trusts and all of the data related to the underlying bonds of the trusts. FIGS. 2A-2C shows a block diagram of the basic database architecture of the database 20 in accordance with an exemplary embodiment of the present invention. In particular, FIG. 2A shows the main database tables of the database 20. As shown in FIG. 2A, a Trust ID links to all of the data related to the trust in the underlying tables. Moreover, the Trust ID is linked to a user depending on the level of access such that customer users will only have access to the data of trusts associated with the customer while an administrator will have access to the data of all the trusts in the system.

The information stored in the database 20 may include trust characteristics, bond information, payment information, trust documents, and a calendar of events (e.g., maturity date, coupon date, etc.). The information in the database 20 may be populated from the various users (e.g., trustee uploading trust documents) and/or receive information automatically from external sources, such as third party pricing services (e.g., pricing information of underlying assets). The received data is normalized into a common format and stored in the database 20.

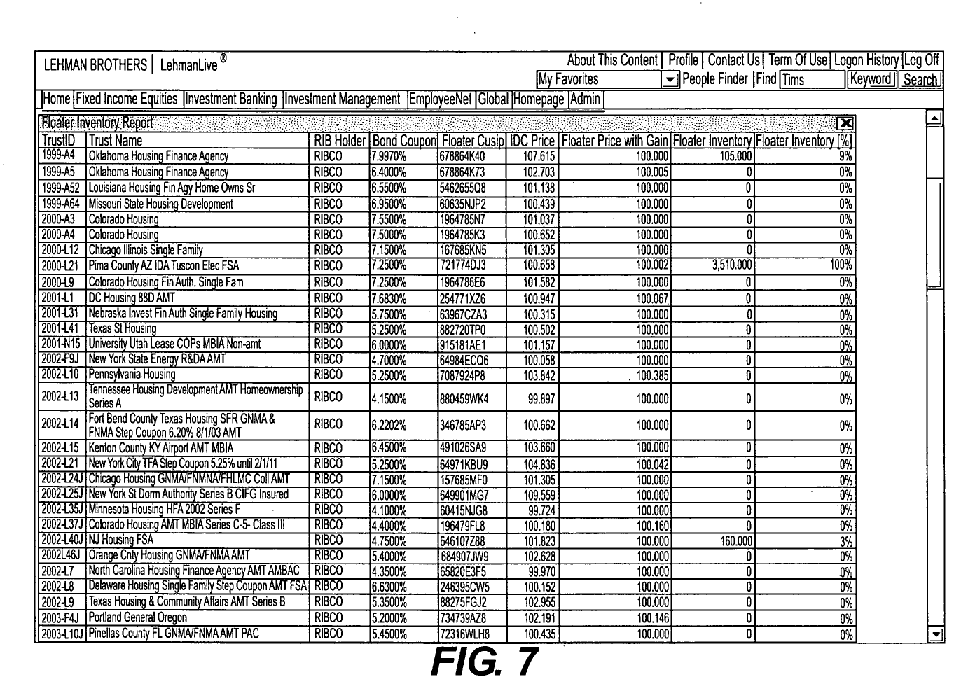

As shown in FIG. 1, TIMS application 40, which resides on the TIMS server 10, provides a single platform on which all of the trust information may be managed to monitor the trust activities. The TIMS application 40 allows users to easily access and manage detailed information about the their trusts including interactive tools through which users can update relevant data, run customized reports, and communicate with one another including an on-line ticketing system that enables a user to propose new positions to the system provider or to the broker/dealers. In particular, the TIMS application 40 maintains information about the bonds deposited in the trust and is updated to reflect calls, changes in leverage, and change in ratings, for example. Moreover, the TIMS application 40 maintains historical floater and inverse floater rates. Accordingly, users can retrieve inverse floater rates, for example, for the current period or view historical rates to easily determine how the floaters have performed over time. Additionally, the TIMS application 40 includes a Floater Inventory module that tracks and notifies users of floaters that are available for purchase (FIG. 7). Because the TIMS server 10 is in communication with a trading system that provides real-time trade updates, when floaters are acquired and added to the floater inventory, users are notified of the floaters available in the floater inventory.

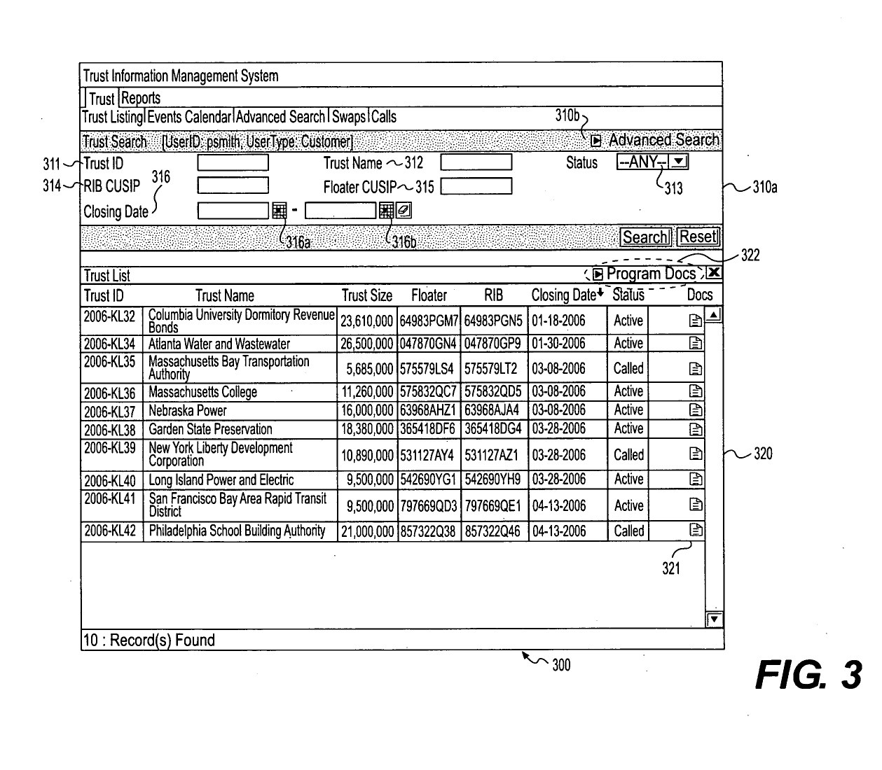

As shown in FIG. 3, the TIMS application 40 includes a Trust Search module 300. The Trust Search module 300 includes a search engine 310 and a Trust List module 320. By default, the Trust List module 320 is populated with all of active trusts from database 20 associated to the user. The trust information may vary depending on the access level of the user. For instance, a system administrator may be presented with all of the active trusts in the system while a customer user may be presented with only the active trusts owned by the customer. The default population may be customized so that the trust listing screen may be automatically populated with a different status (e.g., “Any”).

The search engine 310 searches the database 20 for trusts based on the entered search criteria. In this exemplary embodiment, a simple search module 31Oa may be used to search the database 20. For instance, the database 20 may be searched for trusts based on the status of the trust (e.g., Status (313); ACTIVE, CALLED, MATURED, or ANY). Other examples of search parameters include Trust ID (311), Trust Name (312), Residual Interest Bonds (“RIB”) CUSIP (314), Floater CUSIP (315), and Date (316). An identification number is assigned to all stocks and registered bonds by the Committee on Uniform Securities Identification Procedures (CUSIP). The Date field (316) may include Calendar module (316a, 316b) that displays a calendar (not shown) to input the desired date in the Date field (316). For advanced searching using more detailed parameters, advanced search module 31Ob may be used. Other search parameters may be used without departing from the scope of the present invention.

The results of the search (or default parameter) are then displayed in the Trust List module 320. The trusts may be listed by Trust ID, Trust Name, Trust Size, Floater CUSIP, RIB CUSIP, event date (e.g., Closing Date), and Status. Other categories of information may be added or deleted from the Trust List module 320 without departing from the scope of the invention. Each of the trusts displayed in the Trust List module 320 are active links to the detailed information of the trust. Therefore, selecting a trust in the list invokes a Trust Details module 400, to be discussed in detail below, to display detailed information about the selected trust. The Trust Search module 300 further includes active document links 321 to invoke the trust-specific documents (e.g., PPM supplements, liquidity agreements, credit ratings, etc.) associated with the trust. The Trust Search module 300 also includes program document link 322 that displays a list of program documents (i.e., base documents). All of the documents may be viewed or downloaded to the user's device.

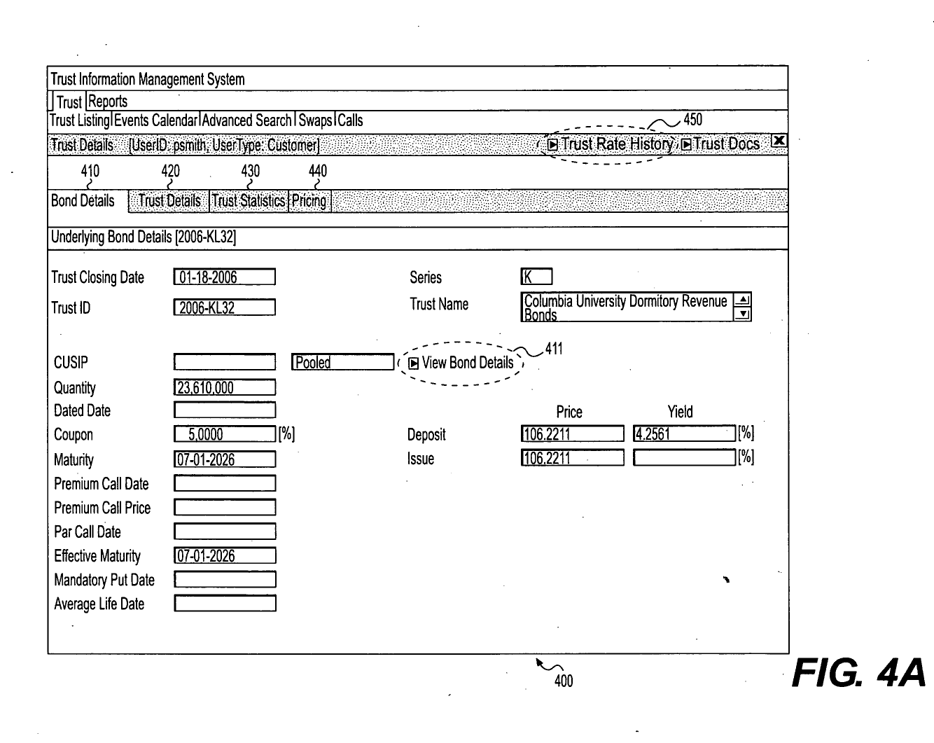

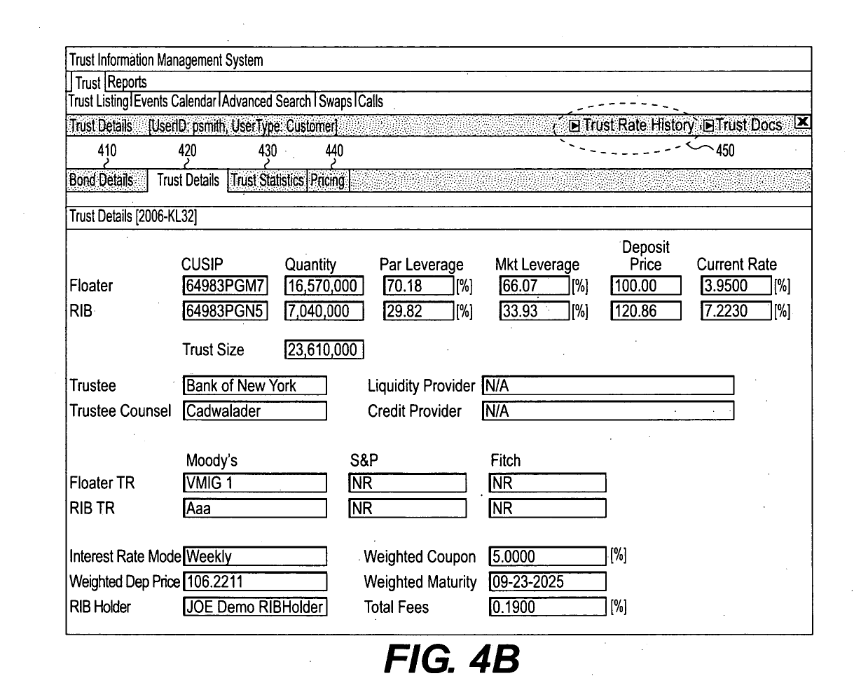

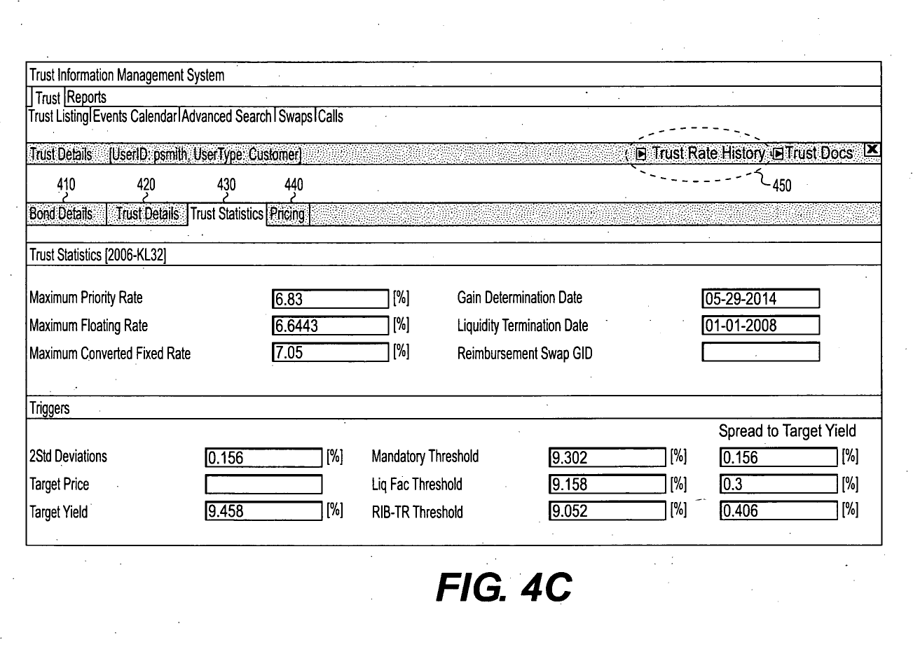

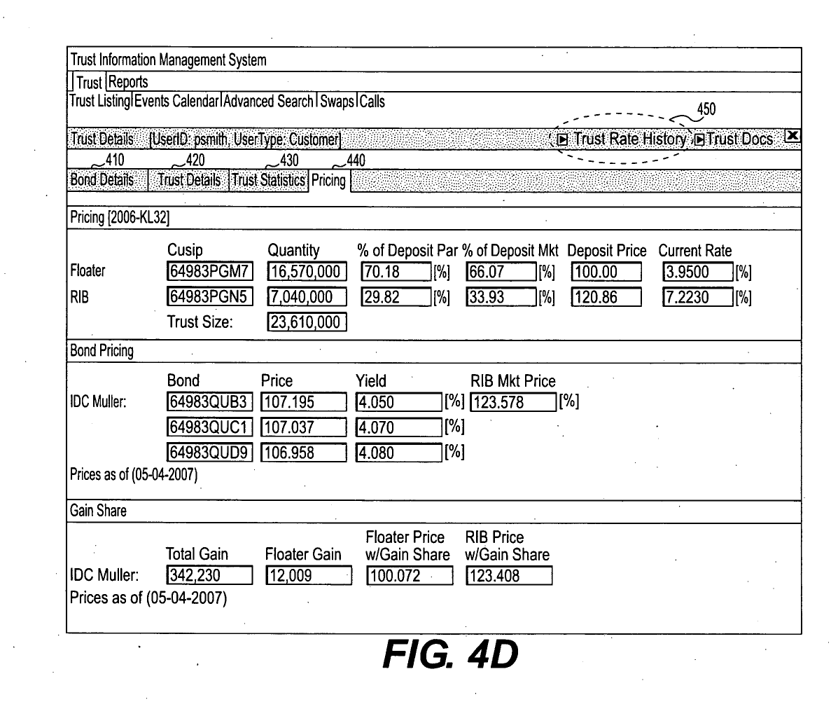

When a trust is selected from the Trust List module 300, the TIMS application 40 includes a Trust module 400 (FIGS. 4A-4D). The Trust module 400 includes Bond Details module 410, Trust Details module 420, Trust Statistics module 430, and Pricing module 440. As shown in FIG. 4A, the Bond Details module 410 gathers the information of the underlying bond of the selected trust from the database 20 and displays the bond information. The Bond Details feature 411 provides a list of all of the underlying bonds of the selected trust.

As shown in FIG. 4B, the Trust Details module 420 gathers the trust information from the database 20 and displays the trust information of the selected trust. In particular, the Trust Details module 420 provides both the floater and RIB data of the trust as well as the leverage and current ratings of the trust.

As shown in FIG. 4C, the Trust Statistics module 430 calculates and provides statistical analysis of the performance of the selected trust. In particular, the Trust Statistics module 430 provides information on the triggers related to the program of the selected trust and other statistics, such as gain determination dates and percentages.

As shown in FIG. 4D, the Pricing module 440 gathers the price information of the various components of the trust. In particular, the Pricing module 440 provides the price information of the floater, RIB, underlying bond, and the gain share of the various components of the trust, all in one module.

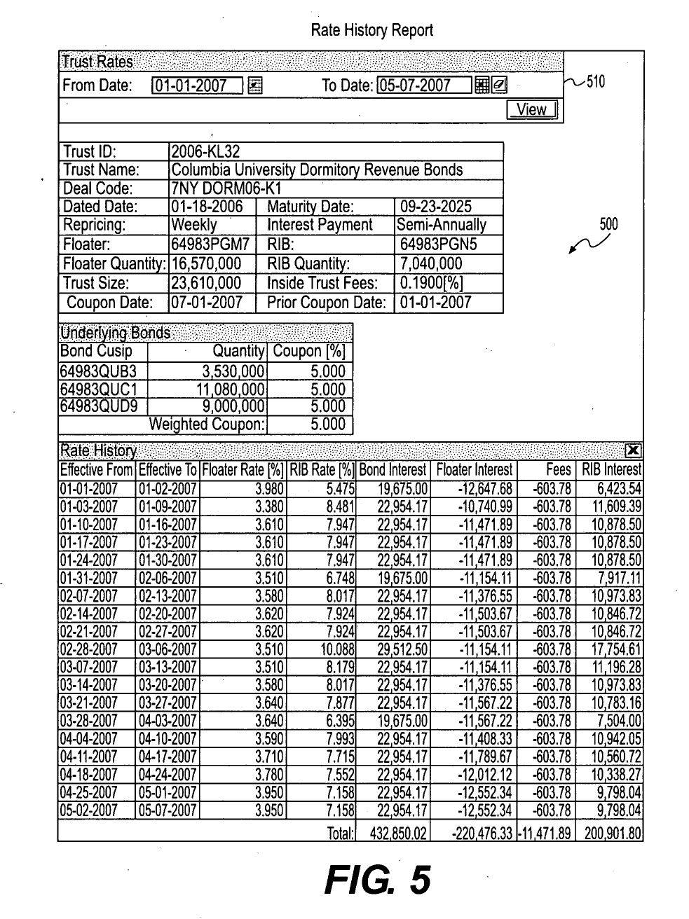

The Trust module 400 further includes a rate history link 450 to invoke a Trust Rate History module 500. The Trust Rate History module 500 performs a detailed analysis of the rate history of the trust. As shown in FIG. 5, the Trust Rate History module 450 gathers the rate history data from the database 20 and provides a detailed report of the rate history of both the floater and RIB components of the trust. The Date Selection module 510 changes the time frame for the rate history analysis. While the system may be set to default the “From Date” to the last coupon payment date and the “To Date” to the current date, other time frames may be designated for the rate history report. The rate history report then displays the rates at each event date for the time period designated in the Date Selection module 510. The Trust Rate History module 500 calculates and displays a weighted average floater and inverse floater (i.e., RIB) rates.

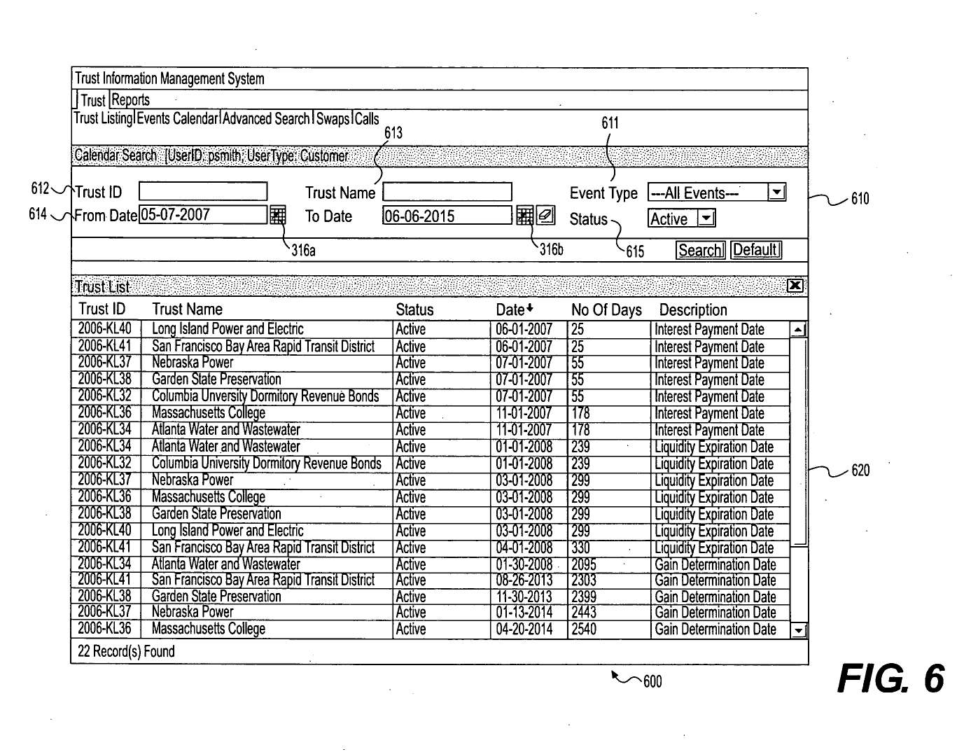

The TIMS application 40 further includes an Event Calendar module 600. As shown in FIG. 6, the Event Calendar module 600 includes a calendar search engine 610. In this exemplary embodiment, calendar search engine 610 may be used to search the database 20 for trusts based on the type of event. For instance, the database 20 may be searched for trusts according to the following Event Type (611): Closing Date, Maturity Date, Gain Determination Date, Liquidity Expiration Date, Par Call Date, Premium Call Date, and Interest Payment Date. The database 20 may be searched for other events without departing from the scope of the present invention. Other examples of search parameters include Trust ID (612), Trust Name (613), Date (614), and Status (615). Calendar module (614a, 614b) may be used to enter the dates from a calendar. While the default may be “All Events,” the default setting may be changed without departing from the scope of the present invention.

The results of the search are displayed in the Trust List module 620. In particular, Trust List module 620 displays the trusts found by the calendar search engine 610 including the Trust ID, Trust Name, Status of the trust, Date of the event, Number of Days to the event, and the Description of the event. As with the Trust List module 320 of the Trust module 300 (i.e., FIG. 3), the trusts listed in the Trust List module 620 may be selected to access the details of the trust.

It will be apparent to those skilled in the art that various modifications and variations can be made in the trust information management system of the present invention without departing from the spirit or scope of the invention. For instance, while the description is based on a server-client platform with the TIMS application 40 resident on the TIMS server 10, other architectures may be used without departing from the scope of the invention. For example, the TIMS application 40, or any modules thereof, may be resident in the remote device 30 and the TIMS server 10 provides the requested data from the database 20. Thus, it is intended that the present invention cover the modifications and variations of this invention provided they come within the scope of the appended claims and their equivalents.

What is claimed is:

1. A system, comprising:
a database including data of at least one trust and at least one bond, the data of at least one bond being associated with at least one trust holding at least one bond, the data of the at least one trust including at least floater data; and
a server to manage the data of the at least one trust and the data of the at least one bond associated with the at least one trust.

2. The system of claim 1, wherein the data of the at least one trust includes inverse floater data.

3. The system of claim 1, wherein the server includes a search engine configured to search the database.

4. The system of claim 3, wherein the search is based on a trust event.

5. The system of claim 4, wherein the trust event includes at least one of closing, maturity, gain determination, liquidity expiration, par call, premium call, and interest payment.

6. The system of claim 3, wherein the search is based on a trust status.

7. The system of claim 6, wherein the trust status includes at least one of active, called, and matured.

8. The system of claim 1, wherein the server includes a rate history module configured to produce a history of rates associated with the at least one trust.

9. The system of claim 8, wherein the history of rates includes at least floater rates.

10. The system of claim 8, wherein the history of rates includes at least inverse floater rates.

11. The system of claim 1, wherein the server includes a pricing module configured to provide pricing information for at least one floater of the at least one trust.

12. The system of claim 1, wherein the server includes a pricing module configured to provide pricing information for at least one inverse floater of the at least one trust.

13. The system of claim 1, wherein the server includes a statistics module configured to provide trust statistical information.

14. The system of claim 13, wherein the trust statistical information includes at least one of a gain determination date, liquidity termination date, and triggers.

15. The system of claim 1, wherein the server includes a floater inventory module configured to track floaters available for purchase.

16. A device, comprising:
a communication unit to communicate with a database, the database including data of at least one trust and at least one bond, the data of at least one bond being associated with at least one trust holding the at least one bond, the data of the at least one trust including at least floater data;
a computing unit to process the data of the at least one trust and the data of the at least one bond associated with the at least one trust; and
a display unit to display the data of the at least one trust and the data of the at least one bond associated with the at least one trust.

17. The device of claim 16, wherein the data of the at least one trust includes inverse floater data.

18. The device of claim 16, wherein the computing unit is configured to communicate with a search engine to search the database.

19. The device of claim 18, wherein the search is based on a trust event.

20. The device of claim 19, wherein the trust event includes at least one of closing, maturity, gain determination, liquidity expiration, par call, premium call, and interest payment.

21. The device of claim 18, wherein the search is based on a trust status.

22. The device of claim 21, wherein the trust status includes at least one of active, called, and matured.

23. The device of claim 16, wherein the computing unit is configured to communicate with a rate history module to produce a history of rates associated with the at least one trust.

24. The device of claim 23, wherein the history of rates includes at least floater rates.

25. The device of claim 23, wherein the history of rates includes at least inverse floater rates.

26. The device of claim 16, wherein the computing unit is configured to communicate with a pricing module to provide pricing information for at least one floater of the at least one trust.

27. The device of claim 16, wherein the computing unit is configured to communicate with the pricing module to provide pricing information for at least one inverse floater of the at least one trust.

28. The device of claim 16, wherein the computing unit is configured to communicate with a statistics module to obtain trust statistical information.

29. The device of claim 28, wherein the trust statistical information includes at least one of a gain determination date, liquidity termination date, and triggers.

30. The device of claim 16, wherein the computing unit is configured to communicate with a floater inventory module to track floaters available for purchase.

31. A computer program product including computer executable instructions embodied on a computer readable medium, the instructions, when executed on a computer, causing the computer to perform a method comprising the steps of:
communicating with a database, the database including data of at least one trust and at least one bond, the data of at least one bond being associated with at least one trust holding the at least one bond, the data of the at least one trust including at least floater data;
processing the data of the at least one trust and the data of the at least one bond associated with the at least one trust; and
displaying the data of the at least one trust and the data of the at least one bond associated with the at least one trust.

32. The computer program product of claim 31, wherein the data of the at least one trust includes inverse floater data.

33. The computer program product of claim 31, wherein the step of processing the data includes searching the database.

34. The computer program product of claim 33, wherein the search is based on a trust event.

35. The computer program product of claim 34, wherein the trust event includes at least one of closing, maturity, gain determination, liquidity expiration, par call, premium call, and interest payment.

36. The computer program product of claim 33, wherein the search is based on a trust status.

37. The computer program product of claim 36, wherein the trust status includes at least one of active, called, and matured.

38. The computer program product of claim 31, wherein the step of processing the data includes producing a history of rates associated with the at least one trust.

39. The computer program product of claim 38, wherein the history of rates includes at least floater rates.

40. The computer program product of claim 38, wherein the history of rates includes at least inverse floater rates.

41. The computer program product of claim 31, wherein the step of processing the data includes providing pricing information for at least one floater of the at least one trust.

42. The computer program product of claim 31, wherein the step of processing the data includes providing pricing information for at least one inverse floater of the at least one trust.

43. The computer program product of claim 31, wherein the step of processing the data includes obtaining trust statistical information.

44. The computer program product of claim 43, wherein the trust statistical information includes at least one of a gain determination date, liquidity termination date, and triggers.

45. The computer program product of claim 31, wherein the step of processing the data includes tracking floaters available for purchase.
